(19) United States
(12) Patent Application Publication
(10) Pub. No.: US 2018/0365279 A1
(43) Pub. Date: Dec. 20, 2018

(54) User-controlled iterative sub-clustering of large data sets guided by statistical heuristics

(71) Applicant: Perspicamus Ab, Helsinki (FI)

(72) Inventor: Mauri KAIPAINEN, Stockholm (SE)

(73) Assignee: Perspicamus Ab, Helsinki (FI)

(21) Appl. No.: 16/010,574

(22) Filed: Jun. 18, 2018

(30) Foreign Application Priority Data
Jun. 16, 2017 (FI) 20177075

(51) Int. Cl. G06F 17/30

(52) U.S. Cl. CPC G06F 17/30342; G06F 17/30345

(57) ABSTRACT

The current invention is related to data analysis, and in particular, various methods for cluster analysis. It provides a method that aims to summarize and illustrate an original data set by means of breaking it iteratively into sub-divisions, altogether comprising a hierarchical cluster structure. The method comprises at least the steps of collecting a parametrically predetermined number of samples from a given original data set in which each data item is described by a vector of values, and iterating each of the following steps at least once: presenting to the user the hierarchical cluster structure composed by already completed iterations, the list of variables specified by the data set presented in a manner that indicates a heuristic for optimal distinctivity within the cluster, receiving from the user a selection of a supercluster to be sub-divided and a sub-divisive variable, collecting a sample of a fixed number of items from the original data set such that fall within the union of interval values for each of the variables that defined the supercluster in previous iterations, and performing a sub-division on said elected divisive variable on said cluster.

### BACKGROUND OF THE INVENTION

### Field of the Invention

The current invention is generally related to data analysis, data mining, and in particular, various methods of cluster analysis.

### Description of Related Art

The condition of decision making grounded on data is that the observations can be organized into meaningful and actionable structures. This need is urgent and emphasized when digitally organized activities of organizations and networks generate very large numbers of records. Cluster analysis refers generically to data analysis that aims to identify homogeneous groups of observations within multi-variate data, such within which the objects are similar with respect to particular criteria. Such groups, termed clusters, allow effective targeting of actions to a number of objects at a time. Such analysis is applied typically to large amounts of non-hierarchical data, such as customer data, product data, or sales data, that may embed valuable information, yet it is not clear in advance what would be the best way to partition it. The challenge of data clustering has been one of intensive development within computer science, statistics and a number of application areas since 1930, generating a vast number of literature. A rather generic taxonomy can be destilled from this literature as follows:

1. Hierarchical cluster analysis
1.1 Agglomerative (bottom-up)
1.2 Divisive (top-down)
   1.2.1 Unsupervised
   1.2.1 Supervised

### Table 1. A Generic Taxonomy of Clustering Methods

Hierarchical cluster analysis (HCA) aims to represent objects of data in clusters that are nested within others. HCA is also suitable for describing structures in data such in which variables have varying degrees of significance as criteria of similarity. It can be abstracted that those with higher significance determine more global clusters, and those with lesser significance define more local sub-divisions within these. Methods of hierarchical cluster analysis break down to two categories according to the direction of organization, namely agglomerative (bottom-up) and divisive (top-down). Divisive methods are by definition more suitable for deductive analysis driven by given analytic presuppositions, while the agglomerative approach may describe better an analytic process without presuppositions.

The dominant academic interest within the associated research communities has been in unsupervised (automatized) clustering, aligned with the mission of artificial intelligence.

The rapidly expanding accumulation of data in massive industrial and organisational and socio-technological systems, often referred to as “big data”, motivates a growing interest to exploit the information not only in strategic but even frequent operative data-driven decision making. It has turned out however, that the unsupervised clustering approach does not automatically provide representations that best inform such decisions.

In most data accumulated from observations of behaviour or natural phenomena, there are multiple highly covariant and redundant variables. In general terms, clustering can be regarded as a means of reducing the dimensionality of the variable space, in principle a nonlinear transformation, which implies some kind of prioritization among the variables, be it in terms of weights or order of application.

In unsupervised clustering algorithms, the prioritization generally follows some kind of statistical optimization procedure. In a typical use situation, hierarchical cluster analysis is implemented by means of computer software that takes a matrix of data as its input, in which each observation is represented by a vector. Many of these analyses run chosen algorithms in an automated manner, constrained in advance only by a few given parameters, such as the desired number of sub-divisions. The output of the analysis may take various forms, such as scatter plots, nested areas, dendrograms, embedded lists and narrations representing the identified data structure.

However, there is a number of issues limiting the usefulness of unsupervised hierarchical cluster algorithms for practical analytic purposes beyond academic interest. A central problem is apparently how to accommodate human insights with statistical optimization.

First, the outcome of cluster algorithms depends crucially on the implicit prioritization among variables performed by the chosen algorithm in a black-box manner, regardless of human insights, analytic needs and contexts related to the task at hand. This often leads to a lack of relevance between the resulting cluster structure and the analytical task. Due to this, the explanatory contribution of the results may often be limited.

Another set of issues with clustering in general relates to the opaque nature of the complex automated procedure and the consequent implicit nature of the result, making it difficult to evaluate and interpret. Due to the character of the computational process as a nonlinear dimensionality reduction, it is not directly obvious in the resulting clustering how and which variables were selected as criteria to determine the clustering. This is most obvious with spatial representations of the cluster structure, where it is difficult to associate cluster-defining variables with spatial axes. Furthermore, the borderlines of clusters remain often unclear. Because of these reasons, the results are typically not directly actionable, but require further analysis, for example by means of regression analysis. This in turn implies costs in terms of expertise and time spent.

Secondly, known methods of cluster analysis generally fail to take full advantage of the fact that multiple equally justifiable cluster structures can describe any set of multi-variate data. This leads to certain arbitrariness of the results, which is intellectually unsatisfactory and leaves most of the potential cluster structures implicit in the data set unexplored and unexploited.

These and related issues have been recognized by throughout literature, in particular those that report experiences of practical applications. In conclusion, supervised clustering algorithms are conceptually and procedurally complex, difficult to interpret, exploit, and to relate with the analytic task, whereby they require a high level of expertise and expensive resources.

The present invention is aimed to solve these issues by providing a method and software tools in order to allow the user to control the procedure of divisive hierarchical cluster analysis in an iterative manner, supported by statistics-based heuristics, and therewith support exploring alternative cluster structures without the assistance of experts.

An abundance of patent documents describe different cluster analysis methods. For example, the patent application US20110246409A1 describes processes and machines that can be used to reduce a large amount of information into meaningful data and reduce the dimensionality of a data set. That application describes user interaction in the choice of a variable (feature) selection that determines the statistical analysis. However, that method and software requires two data sets, making the method overly complicated for the non-expert user.

The patent application US20060122816A1 describes a method for identifying a quantitative trait (feature) loci for a complex trait that is exhibited by a plurality of organisms in a population. That application, belonging to the area of bioinformatics, allows the analyst to choose sub-dividing variables (“classification schemes”) in a supervised way. This choice is, however, associated with other criteria than statistical analysis.

### SUMMARY OF THE INVENTION

An embodiment of the invention provides a software-supported interactive system of sub-divisive hierarchical cluster analysis for large data sets through representative samples, implemented as user-controlled iterative procedure guided by statistical heuristics.

In this embodiment, each iteration is based on the analyst's choice of the subset of data (cluster) and the variable to sub-divide. These choices are based, on one hand, on available analytic insights, presuppositions, semantic or contextual information regarding the task (hereafter called the analytic task), and on the other, statistical heuristics recommending variables as candidates for selection with optimal distinctivity among the items within the sample. This approach gives the user an explicit control of the sequential prioritization of variables that determines the hierarchical cluster structure while guaranteeing is direct association with the analytic task. At the same time, the statistical heuristics provided by the system helps the analyst to avoid highly covariant or redundant sub-divisions, such as “the cheapest among the least expensive”.

In this embodiment, in response to the analyst's choice of the clusters to sub-divide and the sub-divisive variable, the analytic software determines breaking points in the distribution of the objects within the supercluster along the chosen variable and presents the thus determined sub-divisions in chosen form, for example in terms of adding branches to a dendrogram. The invention is not committed to any particular clustering algorithm. The literature knows a number of alternatives applicable for this step, for example largest interval, or sparsest density.

In this embodiment, the procedure of sub-divisions is iterated until clusters or cluster structures are identified such that satisfy the constraints of the analytic task. As an example of such constraints, the analyst may look for subclusters that represent certain proportion of a market, yet are distinct enough and encapsulate a population in which certain variables correlate, implying successful marketing efforts. In general, the user's control over the end conditions of the iterative process is a significant advantage over most unsupervised clustering methods, saving computational resources and cognitive clutter.

In a further embodiment of the invention, the software comprises a dynamical functionality for representative random sampling from the original large data set for each sub-division in order to allow full scaleability to arbitrarily large sets of data without exceeding the capacity of the a available computing system. The sample size parameter, which also determines the degree of reliable representativeness and the level of resolution, can be adjusted to a purposeful level.

The outcome of the analysis is a summary of the entire data expressed in a form that represents the hierarchical cluster structure and the proportions of objects, for example using scatter plots, nested areas, dendrograms, embedded lists and narrative text descriptions.

The advantages of the invention include that the criteria of cluster sub-divisions are explicitly known at each hierarchical level, and their relevance to the analytic task is guaranteed per definition, while being based on statistically maximally effective distinctions. The user control over the iterative process also limits the hierarchical depth to the level required by the analytic task, thereby avoiding conceptual noise and saving computational resources.

Also, this way of approaching cluster analysis permits the exploration of the data more flexibly and spontaneously from different alternative analytical perspectives than solutions based on the prior art.

For example, the data set may include pairs of variables that do not covary strongly in the global scale of the data, but may have a significant co-dependence within a local scope. Such relations tend to get averaged out in a standard clustering analyses. The inventive explorative and task-driven way of clustering data stepwise towards increasingly more detailed distinctions is effectively instrumental in order to identify such local interdependences.

In this specification, we use the concept of dimension to denote a variable, or a combination of variables, in which a step of cluster analysis is performed. This combination of variables can be, for example, of a weighted combination of variables or any other mathematical function of a plurality of variables from the data set.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

Various embodiments of the invention will be described in detail below, by way of example only, with reference to the accompanying drawings, of which

FIG. 1 illustrates an user interface according to an embodiment of the invention, and

FIG. 2 illustrates a method according to an embodiment of the invention.

### DETAILED DESCRIPTION OF SOME EMBODIMENTS

The following embodiments are exemplary. Although the specification may refer to “an”, “one”, or “some” embodiment(s), this does not necessarily mean that each such reference is to the same embodiment(s), or that the feature only applies to a single embodiment. Features of different embodiments may be combined to provide further embodiments.

In the following, features of the invention will be described with a simple example of a cluster analysis method with which various embodiments of the invention may be implemented. Only elements relevant for illustrating the embodiments are described in detail. Details that are generally known to a person skilled in the art may not be specifically described herein.

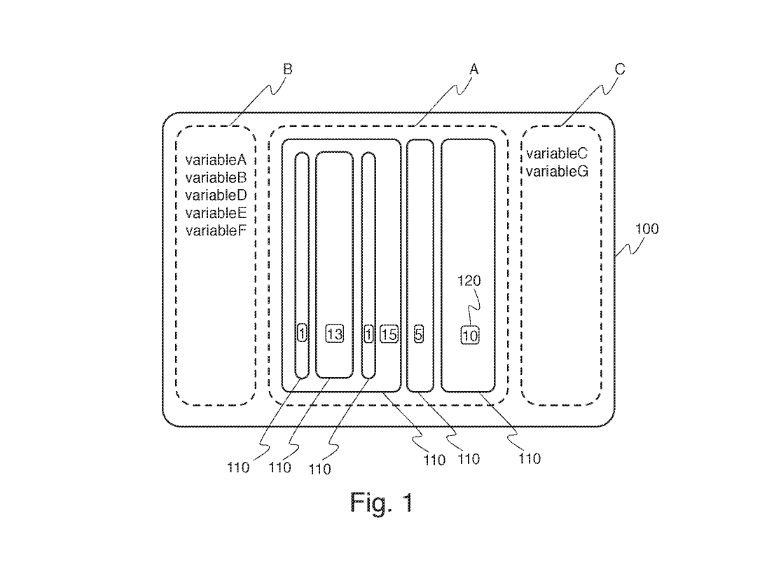

In an embodiment of the invention, the software supporting iterative subclustering analysis provides a user interface which comprises of three areas. This embodiment is illustrated in FIG. 1, which illustrates an user interface 100. The first panel (A) shows the results of the previous step of analysis, the resulting cluster structure, as a system of mutually embedded rectangles 110, the area of which implies the proportion of objects per all objects it covers. An area can be chosen for further operations or scrutiny by mouse-clicking on its area.

The second panel (B) shows a list of variables listed by descending orthogonality against the variable that was applied as the last sub-division criterion. This serves as an indication of with respect to which variables the objects of the cluster under scrutiny differ most.

In turn, the variables that are least orthogonal against the last sub-division criterion, that is, those most covariant with it, are listed at the end of the same list, an important explanatory indicator.

This kind of presentation allows the user to easily choose the variable for the next step of cluster analysis that provides most orthogonal sub-division of the supercluster. This is at the same time a means of finding optimally informative sub-divisions and avoiding strongly covariant variables that cannot offer by redundant information.

The third panel (C) lists variables that have already been applied to determine the hierarchical structure shown in panel (B), indicated by a gray background. They can be interpreted as independent (given) variables, while the ones not so indicated correspond to dependent ones. In addition, in a further embodiment there is a mouseover function that indicates average values of each independent and dependent variable within the cluster pointed at, for example by means of font size. However, other measures besides orthogonality can also be used as a metric in proposing of new variables to use in the following steps of cluster analysis.

In various embodiments of the invention, results of the cluster analysis can be shown in the user interface in many other ways than the example illustrated in FIG. 1. For example, the cluster analysis results can be shown as a tree structure or, for example, in a textual hierarchy, narrative or a graphical representation indicating clusters and locations of data points within those clusters. A person skilled in the art of visualization will know a number alternative ways of representing results of cluster analysis.

In another embodiment of the invention a sum of values for a selected variable within each cluster in the representation of cluster analysis results is calculated and shown in the user interface. This is illustrated in FIG. 1 by the values 120. These calculated properties would allow an analyzer to more easily recognize meaningful and important clusters in the data set. For example, the cumulative sum of sales for objects of that cluster might provide instantly actionable additional information. In a further embodiment of the invention the user of the software can define which calculated properties or functions of variables to show on the user interface.

A computer program implementing the inventive method can reside on any programmable digital apparatus, including local and cloud servers, distributed systems, desktop and portable computers as well as mobile devices.

The invention has a number of benefits. The stepwise approach to cluster analysis allows the user to explore several different perspectives to the data, that is, several different sequences of sub-divisions.

The inventive stepwise approach also allows cluster analysis by people who are not deep experts in cluster analysis. The inventors have observed that in the literature of the cluster analysis field a common theme is that cluster analysis is a highly demanding art which requires high expertise from the analyzers. However, the present inventive approach allows also non-expert users to explore a data set using cluster analysis.

A further advantage of the present stepwise approach is that the inventive approach combines the phases of dimension reduction and data analysis, which are commonly needed in traditional cluster analysis. The present approach also diminishes or eliminates the need of purging non-relevant dimensions from the data set as the functionality of automatically proposing orthogonal dimensions for the next step of cluster analysis pushes non-relevant dimensions further down in the list of proposed dimensions, thus reducing the probability of the use of those dimensions in the cluster analysis.

The stepwise approach of the current invention also removes a problem that is present in methods of prior art for cluster analysis, namely the need to clarify the relationships between the variables. This phase is typically a demanding task requiring high expertise. In the present inventive approach, the variables are explicit, due to the analyst's choice. Therefore, the inventive approach to stepwise cluster analysis provides significant savings in time and effort in cluster analysis.

A further benefit of the inventive approach to cluster analysis is that the heuristics for dimension in the next sub-divisive step, that is prioritization of the dimensions, brings out any hierarchies or hierarchal structures existing in the data.

A further benefit of the inventive approach to cluster analysis is that since the inventive approach allows exploration of the data space through different variables and variable combinations, the inventive approach also makes it possible to gauge the strength of any given observation or cluster analysis result. If a certain cluster appears through several different approaches it means that the observation of the cluster in the set of data is stronger than a cluster that appears in only one approach. This allows validation of the results of the cluster analysis.

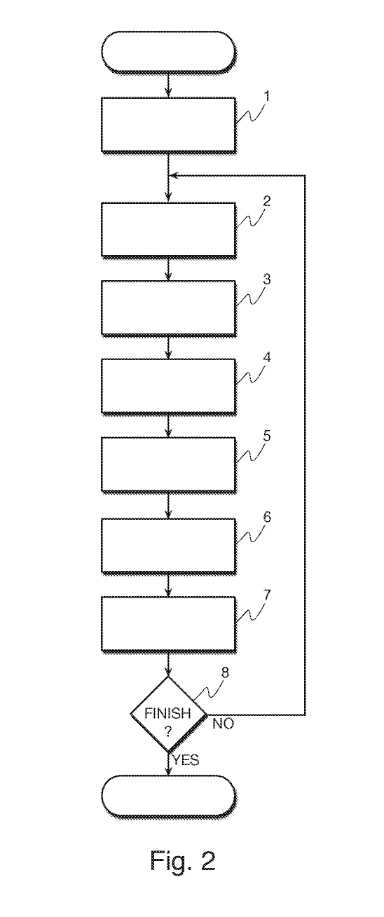

In the following, we describe a method in a computer-implemented system according to an embodiment of the invention, and how a user can interact with such a method, with reference to FIG. 2. In this embodiment, in step 1, the system initially allows the user to choose a data set to be analysed, and collects a pseudorandom or random sample of data from the data set. The size can be predetermined, and/or the user may be able to adjust the size of the sample of data.

Then, the following steps 2 to 7 are iterated as long as the user wishes to explore the data set.

In step 2, the system lets the user scrutinize information about the items collected into each cluster in previous iterations. Before first sub-divisions all items of the sample are represented as a single initial cluster. Based on the provided information, the user may consider whether the goals of the analytic task have been reached or not, and choose following accordingly. The first mentioned conclusion may constitute the end condition of the iteration and justify the adoption of the determined clusters and the cluster hierarchy as an end result.

In the case of the latter, the next possible actions include studying the cluster structure presented by the system, continuing the sub-divisive iteration, reversing the last sub-division, replacing the last chosen sub-divisive variable with another one, and performing sub-divisions in another hierarchical branch.

The user may study the set of clusters presented by the system for example by clicking a cluster's presentation on the display of the system or hovering the mouse or another pointing device over the cluster's presentation on the display of the system. The displayed information may include average values (for example, age) or aggregated sums (for example, sales in currency unit) per variable over the items clustered, or other predetermined indicators.

In this embodiment, the recommended sub-divisive variables for the cluster under scrutiny may be presented as a list sorted in descending order by orthogonality of each against the variable that determined it on the last iteration. The higher this indicator value for a variable, the more sharply the items within the pointed cluster differ with respect to it, and the more additional information the sub-division can provide. In addition to the statistical distinctivity, the choice of the dividing variable may take into account a range of contextual, practical, semantical and cognitive factors associated with the variable.

In a further embodiment of the invention, calculation of orthogonality of variables presented as candidates for selection is performed against more than one of those variables that the user has selected in previous rounds of iterations. In an embodiment of the invention, calculation of orthogonality of candidate variables is performed against all of those variables that the user has selected in previous rounds of iterations. A man skilled in the art knows many different methods for calculating degrees of orthogonality between variables of a data set, and the invention is not limited to using any specific one.

Generally, orthogonality is one measure of redundancy of the variables compared against one or more of those variables that the user has selected in previous rounds of iterations, in the sense that a high degree of orthogonality indicates a low degree of redundancy and vice versa. Covariance is another measure of redundancy that can be calculated to order the list of variables to assist the user in selection of the next variable to base cluster analysis on. A man skilled in the art knows other different methods for calculating a measure of redundancy, whereby the invention is not limited to any specific such measure.

In step 3, the system receives from the user a selection of a variable from the presented variables for the next sub-divisive iteration, and a selection of which cluster to further subdivide. In different embodiments of the invention, this selection can be made in different ways, for example by dragging a tag representing the desired variable onto the graphical representation of a cluster on the display of the system.

In step 4, in response to these choices, the system determines the intervals of values within which items associated with the chosen cluster vary with respect to those variables that have been applied to determine the cluster in previous iterations.

In step 5, the system retrieves a sample, i.e. a predetermined number of data points by pseudorandom sampling from the data source that fall within the intervals determined in step 4. The predetermined number may be specified for example parametrically.

In step 6, the system determines the sub-divisions in the distribution of the items of the sample collected in step 4 along the chosen divisive variable. In this step, the system uses a predetermined algorithmic procedure for cluster analysis. This cluster analysis algorithm may be any cluster analysis algorithm known to a man skilled in the art.

In another embodiment, the sub-division performed to the selected supercluster is also performed for other clusters on the same hierarchical level using the same dividing variable, for the purposes of suggestive comparison between clusters on the same level, however indicating to which cluster the chosen divisive variable applies with the intended distinctive effect.

In step 7, the system presents the determined sub-divisions in a chosen textual or visual form on the display of the system. In different embodiments of the invention, the results of the cluster analysis can be displayed in many different ways. For example by means of dividing the rectangle representing the supercluster into smaller rectangles of areas whose sizes are proportional to the respective amounts of objects falling into each out of the amount of objects in the supercluster.

In step 8, the system finishes the analysis if the system receives an indication from the user to finish analysis, and otherwise returns to step 2.

In another embodiment of the invention, which is suitable for large data matrices and purposes that are concerned about generalizations over an unlimited number of items, a sampling technique can be used as follows. When the system receives a selection of a target cluster to be sub-divided further, the system determines for those variables that have previously been selected by the user for performing cluster analysis on, what are the ranges of data point values for each such variable within the subset of data of the selected target cluster. Then, the system randomly picks data points from the data sources and compares the data points to the determined ranges, and if the data points fall within the determined ranges, they are collected for analysis. This picking, comparison, and collection of data points continues until at least a predetermined number of data points have been collected, after which cluster analysis is performed on the collected sample of data points. Preferably, the predetermined number of data points is chosen so as to secure that the sample suffices to represent the entire population, or the supercluster.

Certain further embodiments of the invention include:

In an embodiment of the invention in a first group of embodiments, a computer-implemented method for supporting cluster analysis of data is provided. In this embodiment the method comprises at least the steps of

retrieving a set of data items from a data source, each data item having a set of variable values, and
performing the following steps at least once:
presenting a plurality of variables determined from the set of data items to a user,
receiving from the user a selection of a cluster to sub-divide,
receiving from the user a selection of one of the presented variables,
performing sub-division applying said selected variable as the sub-division criterion on said selected cluster using a hierarchical cluster analysis method to form an updated hierarchical cluster structure,
displaying said updated hierarchical cluster structure, and
presenting to a user a plurality of said variables ordered according to a measure of redundancy with respect to at least one variable that was previously selected by the user.

In a further embodiment of this first group of embodiments the ordering according to a measure of redundancy is calculated against all variables that were previously selected by the user.

The measure of redundancy can be for example inverse orthogonality, or covariance.

In a further embodiment of this first group of embodiments the method further comprises the step of retrieving a subset of data items from said data source, after receiving from the user a selection of a cluster to sub-divide, said subset of data items corresponding to said selected cluster.

In another embodiment of this first group of embodiments the method further comprises the step of determining the minimum and maximum values taken by items within the chosen cluster for each variable, if any, that were previously applied to determine the chosen cluster, said subset of data items being limited by said minimum and maximum values.

In an embodiment of the invention in a second group of embodiments a non-transitory computer-readable medium having stored thereon computer-readable instructions is provided. In this embodiment executing the instructions by a computing device causes the computing device to:

retrieve a set of data items from a data source, each data item having a set of variable values, and perform the following steps at least once:
presenting a plurality of variables determined from the set of data items to a user,
receiving from the user a selection of a cluster to sub-divide,
receiving from the user a selection of one of the presented variables,
performing sub-division applying said selected variable as the sub-division criterion on said selected cluster using a hierarchical cluster analysis method to form an updated hierarchical cluster structure,
displaying said updated hierarchical cluster structure, and
presenting to a user a plurality of said variables ordered according to a measure of redundancy with respect to at least one variable that was previously selected by the user.

In a further embodiment of this second group of embodiments, the medium further has thereon stored instructions that cause the computing device to calculate the ordering according to a measure of redundancy against all variables that were previously selected by the user.

As the measure of redundancy, for example inverse orthogonality, or covariance can be applied.

In a further embodiment of this second group of embodiments, the medium further has stored thereon instructions that cause the computing device to perform the step of retrieving a subset of data items from said data source, after receiving from the user a selection of a cluster to sub-divide, said subset of data items corresponding to said selected cluster.

In a further embodiment of this second group of embodiments, the medium further has stored thereon instructions that cause the computing device to perform the step of determining the minimum and maximum values taken by items within the chosen cluster for each variable, if any, that was previously applied to determine the chosen cluster, said subset of data items being limited by said minimum and maximum values.

In view of the foregoing description it will be evident to a person skilled in the art that various modifications may be made within the scope of the invention. While a preferred embodiment of the invention has been described in detail, it should be apparent that many modifications and variations thereto are possible, all of which fall within the true spirit and scope of the invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the previous description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

We claim:

1. A computer-implemented method for supporting cluster analysis of data, comprising at least the steps of:
retrieving a set of data items from a data source, each data item having a set of variable values, and
performing the following steps at least once:
presenting a plurality of variables determined from the set of data items to a user,
receiving from the user a selection of a cluster to sub-divide,
receiving from the user a selection of one of the presented variables,
performing sub-division applying said selected variable as the sub-division criterion on said selected cluster using a hierarchical cluster analysis method to form an updated hierarchical cluster structure,
displaying said updated hierarchical cluster structure, and
presenting to a user a plurality of said variables ordered according to a measure of redundancy with respect to at least one variable that was previously selected by the user.

2. The method according to claim 1, wherein the ordering according to a measure of redundancy is calculated against all variables that were previously selected by the user.

3. The method according to claim 1, further comprising the step of retrieving a subset of data items from said data source, after receiving from the user a selection of a cluster to sub-divide, said subset of data items corresponding to said selected cluster.

4. The method according to claim 3, further comprising the step of determining the minimum and maximum values taken by items within the chosen cluster for each variable, if any, that was previously applied to determine the chosen cluster, said subset of data items being limited by said minimum and maximum values.

5. A non-transitory computer-readable medium having stored thereon computer-readable instructions, wherein executing the instructions by a computing device causes the computing device to:
retrieve a set of data items from a data source, each data item having a set of variable values, and
perform the following steps at least once:
presenting a plurality of variables determined from the set of data items to a user,
receiving from the user a selection of a cluster to sub-divide,
receiving from the user a selection of one of the presented variables,
performing sub-division applying said selected variable as the sub-division criterion on said selected cluster using a hierarchical cluster analysis method to form an updated hierarchical cluster structure,
displaying said updated hierarchical cluster structure, and
presenting to a user a plurality of said variables ordered according to a measure of redundancy with respect to at least one variable that was previously selected by the user.

6. The non-transitory computer-readable medium according to claim 5 further having thereon stored instructions that cause the computing device to calculate the ordering according to a measure of redundancy against all variables that were previously selected by the user.

7. The non-transitory computer-readable medium according to claim 5, further having stored thereon instructions that cause the computing device to perform the step of retrieving a subset of data items from said data source, after receiving from the user a selection of a cluster to sub-divide, said subset of data items corresponding to said selected cluster.

8. The non-transitory computer-readable medium according to claim 7, further having stored thereon instructions that cause the computing device to perform the step of
determining the minimum and maximum values taken by items within the chosen cluster for each variable, if any, that was previously applied to determine the chosen cluster, said subset of data items being limited by said minimum and maximum values.
